(19) United States
(12) Patent Application Publication
(10) Pub. No.: US 2026/0238691 A1
(43) Pub. Date: Aug. 13, 2026

(54) SYSTEM AND METHOD FOR INTERACTIVE SCREEN SHARING

(71) Applicant: RingCentral, Inc., Belmont, CA (US)

(72) Inventors: Vivek Wamorkar, Bangalore (IN); Ramkumar HN, Udupi (IN)

(21) Appl. No.: 19/194,631

(22) Filed: Apr. 30, 2025

(30) Foreign Application Priority Data
Feb. 10, 2025 (IN) 202541010914

(51) Int. Cl. H04L 65/403; G06F 3/04842; G06F 3/16; G06F 16/34; G06F 16/955; G06F 40/109; G06F 40/30; G06F 40/58; H04N 7/15

(52) U.S. Cl. CPC H04L 65/403; G06F 3/04842; G06F 3/167; G06F 16/345; G06F 16/955; G06F 40/109; G06F 40/30; G06F 40/58; H04N 7/15

(57) ABSTRACT

A computer-implemented method to interact with an online content being shared is disclosed. The method includes receiving the online content being shared with a participant of an online collaborative session. The method also includes processing the online content being shared to extract a plurality of texts from the online content being shared. Additionally, at least one extracted text from the plurality of texts to be interactable is identified. The method further includes enabling interaction with the at least one extracted text to form an interactable text. The online content being shared is transmitted with the interactable text to the participant. An operation associated with the interactable text is performed in response to a selection by the participant.

### RELATED APPLICATIONS

This application claims the benefit and priority to an Indian Patent Application Number 202541010914 that was filed on Feb. 10, 2025, which is incorporated herein by reference in its entirety.

### BACKGROUND

Recent advancements in online technology and an increase in remote work have increased the usage of collaborative platforms such as video conferencing, webinars, and other online collaborative platforms for presentation purposes. Presentation software such as PowerPoint® or Google Slides™ may be used to present digital content such as a slideshow. In this remote environment, sometimes the digital content being presented includes information that can be interacted with in the local copy of the digital content, but that cannot be interacted with by the audience through the online collaborative platform. For example, in a slideshow, the presenter may provide the audience with a link to a webpage, which the audience cannot click on, copy, or otherwise interact with. When this occurs, the audience is unable to easily click on the link and be taken to the webpage or even copy the link to be pasted into the web browser or be copied for later use. Instead, the audience must resort to typing the address (if the web address is visible) as fast as possible to capture the address in order to navigate to that address using a web browser. In turn, this may cause the presentation to suffer from the distraction of audience members, a need for the audience to resort to self-help accessing information, and/or delays caused by the presenter or a co-presenter having to provide the relevant information that cannot be interacted with, to name a few. Moreover, often times a presentation will not display the uniform resource locator (URL). For example, if a presenter is displaying a webpage, the webpage may include buttons that consist of words or phrases that, when selected, lead to a different web page. In these types of examples, the URL is never displayed to the audience, which makes writing down the URL or resorting to other self-help impossible.

Some have attempted to address these issues by having audience members write down, type, or otherwise save the information that cannot be interacted with by the audience, e.g., a URL address, telephone number, email address, etc. Unfortunately, this is a manual process that is prone to mistakes as the burden is placed on the audience to correctly write down the information and causes audience distraction as the audience tries to write down the information while the presentation is ongoing. Furthermore, this is no solution at all in scenarios where the relevant information is hidden by the use of hyperlinking or where certain words or phrases must be clicked to access the relevant information. Others have attempted to address these issues by having the presenter or a co-presenter manually provide the audience with the information that cannot be interacted with by the audience, e.g., via a chat window in the collaborative platform. Unfortunately, this too is a manual process prone to mistakes as the burden is placed on the presenter or co-presenter to accurately provide the information in the first place, then the burden is shifted to the audience to write down the information correctly.

### SUMMARY

Accordingly, a need has arisen to process and analyze online content being shared, extract the text from the online content being shared, identify what portions of the text are interactable, enable interaction with the extracted text, and transmit the online content being shared to audience members with the interactable text.

In accordance with some embodiments, a computer-implemented method to interact with an online content being shared includes receiving online content being shared with participants of an online collaborative session. The method further includes processing the online content being shared to extract a plurality of texts from the online content. According to some embodiments, the method further includes identifying at least one extracted text from the plurality of texts as interactable. In one nonlimiting example, the method also includes enabling interaction with the at least one extracted text to form an interactable text. The method may further include transmitting the online content being shared with the interactable text to the participants. In accordance with some embodiments, an operation associated with the interactable text is performed in response to a participant selecting an operation.

It is appreciated that in one nonlimiting example, the operation associated with the interactable text is navigating to an online address associated with the interactable link. In accordance with some embodiments, the operation performed may be highlighting the interactable text, or copying the interactable text. In another nonlimiting example, the operation may be providing additional information associated with the interactable text. It is appreciated that, in accordance with some embodiments, the additional information associated with the interactable text may be customized based on a profile associated with the participant. In one nonlimiting example, the participant's profile is associated with a permission of the respective participant. In another nonlimiting example, the participant's profile is associated with the respective age of the participants. In accordance with other embodiments, the operation performed may be providing a meaning associated with the interactable text, translating the interactable text, or providing a summary of the interactable text. It is appreciated that in accordance with some embodiments, natural language processing (NLP) may be performed to provide the summary of the interactable text. In one nonlimiting example, the operation performed is initiating a phone call associated with the interactable text.

It is appreciated that the selection associated with the operation to be performed may be achieved in several ways. In one nonlimiting example, the selection is made by clicking a button of a mouse on the interactable text. In yet another nonlimiting example, the selection is made by hovering a mouse over the interactable text. In accordance with some embodiments, the selection is made via a voice command or may be via a touch screen.

A system for interacting with an online content being shared includes a processor and a memory. The memory stores a set of instructions, that when executed by the processor causes receiving the online content being shared with a participant of an online collaborative session. Moreover, the set of instructions when executed by the processor causes processing the online content being shared to extract a plurality of texts from the online content being shared. Additionally, the set of instructions when executed by the processor causes identifying at least one extracted text from the plurality of texts to be interactable. In some embodiments, the set of instructions when executed by the processor causes enabling interaction with the at least one extracted text to form an interactable text. The set of instructions when executed by the processor causes transmitting the online content being shared with the interactable text to the participant, wherein an operation associated with the interactable text is performed in response to a selection by the participant.

According to some embodiments, the operation is one of navigating to an online address associated with the interactable text, highlighting the interactable text, copying the interactable text, providing additional information associated with the interactable text, providing a meaning associated with the interactable text, translating the interactable text to a different language, providing a summary of the interactable text, or initiating a phone call associated with the interactable text. In one nonlimiting example, the additional information associated with the interactable text for the participant is different from another additional information associated with the interactable text for a different participant of the online collaborative session, and wherein the additional information and the another additional information are customized based on a profile associated with the participant and the different participant respectively. It is appreciated that the profile is associated with a permission of the participant and the different participant respectively or with an age of the participant and the different participant respectively. In one nonlimiting example, the set of instructions when executed by the processor causes performing natural language processing (NLP) to provide the summary of the interactable text. In some nonlimiting examples, the selection is through a click button of a mouse on the interactable text or a hovering of a mouse over the interactable text or a voice command.

In one nonlimiting example, a non-transitory, computer-readable medium storing a set of instructions that, when executed by a processor, cause receiving the online content being shared with a participant of an online collaborative session. The set of instructions when executed by the processor further causes processing the online content being shared to extract a plurality of texts from the online content being shared. The set of instructions when executed by the processor further causes identifying at least one extracted text from the plurality of texts to be interactable. The set of instructions when executed by the processor further causes enabling interaction with the at least one extracted text to form an interactable text. The set of instructions when executed by the processor further causes transmitting the online content being shared with the interactable text to the participant, wherein an operation associated with the interactable text is performed in response to a selection by the participant.

These and other features and aspects of the concepts described herein may be better understood with reference to the following drawings, description, and appended claims.

### BRIEF DESCRIPTION OF DRAWINGS

FIG. 1 is a diagram showing an example of an online collaborative platform according to some embodiments.

FIG. 2A is a diagram of a user sharing content through an online collaborative platform, according to some embodiments.

FIG. 2B is a diagram of an online collaborative platform identifying interactable and non-interactable data within a webpage, according to some embodiments.

FIG. 2C is a diagram of an online collaborative platform transmitting the shared content to an audience with interactable text, according to some embodiments.

FIGS. 3A-3C show an example of a user sharing another content through an online collaborative platform and the online collaborative platform transmitting the shared content in addition to interactable elements, according to some embodiments.

FIGS. 4A-4C show an example where different information related to interactable text is transmitted to different audience members, according to some embodiments.

FIGS. 5A-5D show an example where natural language processing is used to translate and summarize interactable text, according to some embodiments.

FIG. 6 is a relational node diagram depicting a neural network, in an example embodiment.

FIG. 7 is a flowchart for creating elements that are interactable when shared with an online content, according to some embodiments.

FIG. 8 is a diagram of a processing server, in an example embodiment.

### DETAILED DESCRIPTION

The example embodiments described herein are directed to online technology such as collaborative platforms, webinars, and/or online presentation platforms for presenting content to an audience. The collaborative platform may include a communication system configured to facilitate communication between online users. Communication may be through an online forum, e.g., online group, online team, webinar, chat team, etc. The communication system may also facilitate communication between users via telephony and/or video conferencing, etc.

The communication system, such as an online collaborative system, provides an environment that is configured to facilitate data/content exchanges, e.g., audio data, video data, content data (e.g., PowerPoint®, Word®, PDF, etc.), messaging (e.g., instant messaging), etc., amongst users. It is appreciated that the term “user(s)” generally refers to participants or the audience of a communication session whether as host or invitee(s) or team member(s). It is also appreciated that the term “user” is used interchangeably with “member” or “participant” or “audience” throughout the application.

Before various example embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical, or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying,” “enabling,” “rendering,” “utilizing,” “launching,” “calling,” “starting,” “accessing,” “sending,” “conferencing,” “triggering,” “ending,” “suspending,” “terminating,” “monitoring,” “displaying,” “removing,” “performing,” “preventing,” “hiding,” “blocking,” “tracking,” “associating,” “queuing,” “controlling,” “inserting,” “detecting,” “modifying,” “replacing,” “applying,” “rendering,” “emphasizing,” or the like, refer to actions and processes of a computer system or similar electronic computing device or processor. The computer system or similar electronic computing device manipulates and transforms data represented as physical (electronic) quantities within the computer system memories, registers or other such information storage, transmission, or display devices.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

It is appreciated that the embodiments and examples are provided with respect to an online presentation platform for illustrative purposes. However, the embodiments should not be construed as limited thereto.

In a pre-Internet era for presenting content to a group, rather than sharing digital content through a virtual setting/room, physical forms of media were presented in person in order to convey information. For example, content may have been presented through chalkboards, flip charts, projectors, or hand-made slides. Unlike digital content presented in digital platforms such as an online collaborative platform, these forms of physical presentations could not themselves be interactable in any way. For example, digital content can include hyperlinks or URLs, which can be interacted with by clicking on the link in order to be taken to the respective webpage. In contrast, physical forms of content such as flip charts or projectors inherently cannot be interacted with in this manner. Due to the physical, in-person nature of pre-Internet presentations of content, there is no equivalent for present-day hyperlinking or URLs, as any such information must have been provided in a separate chart, projector slide, etc.

The embodiments presented herein arise out of computer technology and are inextricably intertwined with online technology and computers facilitating virtual connections. In a post-Internet environment, content can be presented in the form of digital media and does not need to be limited to one source or type of media. Users can create a group within an online collaborative environment by using, e.g., an online collaborative platform, in order to present and discuss digital content. Although a prevalent example is a slideshow presentation, use of an online collaborative platform allows for multiple forms, types, or sources of content to be displayed throughout a presentation. For example, a presenter may present using a slideshow presentation that includes a URL (that is visible to the audience) to an external webpage or a link to an internal company document on a particular slide, to name a few. Moreover, oftentimes a URL may be embedded within the text and it may not be visible to the audience that the text is linked to a resource (e.g., Internet, internal Wiki page, etc.). For example, a name of a book may be in the presentation where a link embedded within the name of the book can be used to navigate to a webpage to purchase the book. In these instances, the audience may not be aware in the first place that there is additional information being linked that is relevant to the presentation. Furthermore, if the audience is aware that additional information is being linked, the burden is placed on the audience to resort to self-help by writing down or typing the URL being linked in order to later access the relevant information, which is also error prone since many webpages or links have characters such as “?”, “/”, “=”, “&”, as well as having strings of characters that do not amount to any normal meaning in daily life, e.g., https://www.google.com/search? q=url&rlz=1C1ONGR_enUS1068US1068&oq=URL&gs_lcrp=EgZjaHJvbWUqCggAEAA YsQMYgAQyCggAEAAYsQMYgAQyCggBEAAYsQMYgAQyCggCEAAYsQMYgAQyCggDEA AYsQMYgAQyCggEEAAYsQMYgAQyBggFEEUYPDIGCAYQRRg8MgYIBxBFGDzSAQgxNz M1ajBqN6gCALACAA&sourceid=chrome&ie=UTF-8, to name a few. This problem arises in multiple ways in the post-Internet environment. For example, a slideshow presentation may include a word being hyperlinked, meaning that the presenter has embedded a link in a specific word. In another example, if a presenter is displaying a webpage, the webpage may include buttons or words where the user can click on the button or word and be navigated to a different online content.

In this post-Internet environment, the presenter may provide additional, external information in the form of hyperlinks or URLs. Although the presenter can interact with the online content by clicking on the hyperlink or URL, the audience is unable to interact with the online content in the same manner because the hyperlink or URL is presented by the online collaborative platform as plain text (when it is shared) rather than the original interactable text. Unfortunately, in some conventional systems, the burden is placed on the presenter to drop the additional material such as the hyperlink or URL in the chat box of the online collaborative platform. Moreover, often times links (URLs) may be embedded within the text and may not be visible to the audience at all, again placing the burden on the presenter to drop that additional material in the chat box for audience to interact with. Due to this, a need has arisen in the post-Internet environment for a solution that allows audience members to interact with online content being shared in the same or a similar manner in which the presenter is capable of interacting with certain text in the online content, e.g., URLs, hyperlinks, text embedded with links, etc., without requiring the additional steps of the presenter having to drop the additional material or the link in the chat box.

The embodiments described herein arise out of a need in the post-Internet environment to rectify distractions and delays that arise when online content includes text that can be interacted with by the presenter, but not by the audience. Once a group within an online collaborative environment has been created using an online collaborative platform (e.g., Microsoft Teams®, RingCentral®, Zoom®, etc.) that may include the ability for a presenter to share online content such as a slideshow, webpage, document, etc., the online content may include interactable text that is intended to lead the audience to external information related to the online content (e.g., hyperlinks, URLs, etc.). For example, the presenter may present a slideshow presentation where one slide includes a URL to a webpage, a hyperlink to an internal company document, or a translation for a word in a foreign language. In the current post-Internet environment, this information is lost when the shared content is sent by the online collaborative platform and received by the audience as plain text that cannot be interacted with.

As described above, the text within the online content that the presenter can interact with may not be interactable for the audience when it is shared with the audience because it is changed into plain text when being presented through an online collaborative platform. For example, the presenter may include a slide in the presentation with either a URL or a word that hyperlinks a URL. The presenter can interact with the text and access the URL in the native format of the presentation, however, the audience can only see plain text and cannot interact with any such URL or hyperlink. When this occurs, there may be delays or audience distractions caused by the audience trying to access the information, e.g., asking the presenter to drop the information into the chat box, jotting down a URL that is also prone to making mistakes, etc., without interacting with the text. Furthermore, in instances where a word is hyperlinked with a URL, or in instances where online content (e.g., a webpage) may otherwise embed a word, phrase, button, etc., with a URL, the audience is not aware in the first instance that additional information is being linked. Without this knowledge, the audience is unaware that an embedded link can be accessed to provide additional information. As another example, interaction with content is not limited to links but also refer to the ability to select, copy, paste, etc., content. For example, shared content in a presentation that the presenter is presenting on cannot be selected, copied, etc., by the audience. It is appreciated that interaction with links is provided for illustrative purposes and should not be construed as limiting the scope of the embodiments. For example, a member of the audience may wish to interact with the shared content being presented on by receiving a translation of a word, by summarizing a portion of the shared content, by receiving additional information associated with a shared content such as additional features of a product being presented on, etc.

In order to bridge the disconnect and prevent delays or distractions, the online content shared with the participants via applications such as PowerPoint®, Word®, PDF, webpage, etc., may be processed. Shared online content may contain a plurality of texts. In one nonlimiting example, the online content can be a slideshow presentation, which may be broken down into a plurality of texts such as individual words, combined terms or phrases, URLs, etc. A subset of the texts in the presentation may later be enabled for audience interaction and transmitted to the audience in interactable form. Additionally, once transmitted to the audience in interactable form, machine learning (ML) and/or artificial intelligence (AI) (e.g., by performing NLP) may be further utilized in order to translate interactable text or provide a summary of the interactable text, to name a few.

In some embodiments, the processing of the plurality of texts within the online content that is being shared enables the online collaborative platform to identify that one or more of the plurality of texts is intended to be interactable. As such, the online collaborative platform may transmit the online content with one or more of the plurality of texts being provided in the form of interactable text that the audience can interact with and select one or more operations to perform associated with the interactable text. By doing so, delays and audience distractions can be rectified by providing the audience with the same level of information through interactable text as the presenter. For example, the presenter may show a slide that includes a URL to a third-party webpage. In response, the plain text URL may be extracted and subsequently transmitted to the audience in the form of an interactable text that allows the audience to click on the text and subsequently select the option to open the URL in a web browser. In one nonlimiting example, the URL or the content that is being shared may be interacted with, e.g., selected, copied, pasted, etc., by the audience. Notably, the online content is itself being shared with the audience with interactable text through, e.g., screen sharing. This is distinct from the current attempted solutions of providing a URL or other relevant interactable text in a chat room within the online collaborative environment. Whereas the chatroom is always interactable, in the current post-Internet environment screen sharing is not interactable.

In some nonlimiting examples, rather than a providing online content that contains a URL, the online content may contain a word or button with an underlying URL hyperlinked to the word or button. In this example, the audience cannot see the URL associated with the word or button and, unless told so, the audience may be unaware that there is an associated URL. In accordance with some embodiments, the metadata (e.g., descriptive metadata, structural metadata, etc.) associated with the online content being presented may be transmitted to the online collaborative platform and subsequently processed to determine that the word or button has an associated URL. In this example, by processing the metadata associated with the online content, the online collaborative system can determine that the word or button has an associated URL and subsequently present the online content with the word or button in the form of an interactable text that the audience can interact with. By doing so, delays and audience distractions can again be rectified by providing the audience with the same level of information through interactable text as the presenter.

It is appreciated that sharing content via an online collaborative platform, as described in subsequent figures, refer to sharing, e.g., screen sharing, in the online collaborative environment, e.g., Microsoft Teams®, RingCentral®, Zoom®, etc., as opposed to sharing content using other mechanisms, e.g., via email. Moreover, it is appreciated that the embodiments are described with references to text being shared for illustrative purposes and should not be construed as limiting the scope of the embodiments. For example, similar methodologies may be used with references to pictures being shared, to video being shared, etc.

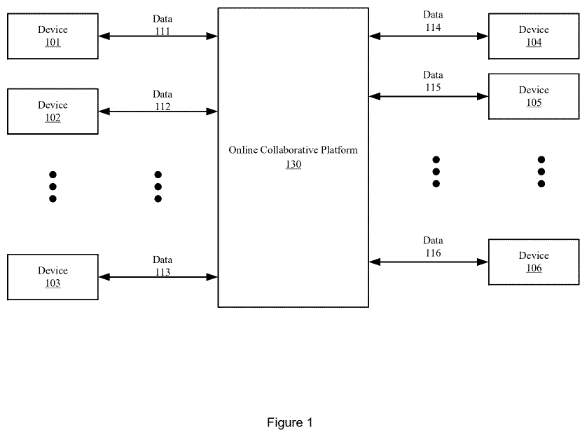

FIG. 1 is a diagram showing an example of an online collaborative platform according to some embodiments. An online collaborative platform 130 may be used to form an online group for online users including their respective devices 101-106. It is appreciated that the online collaborative platform 130 enables the devices 101-106 to share data 111-116 with one another. As one nonlimiting example, the online collaborative platform 130 may be a videoconferencing system (e.g., RingCentral®) where a presenter is using device 101 to share data 111 in the form of an online webpage. It is appreciated that in accordance with some embodiments, devices 102-106 receive the data 111, but also may provide new data (e.g., data 112 to 116) through the online collaborative platform 130. It is appreciated that the data 111 being presented may include a plurality of texts, including individual words, combined terms or phrases, entire paragraphs, URLs, metadata associated with a webpage, etc., which may accompany with audio/video data from the presenter. In one nonlimiting example, data 111 may be a webpage that includes hyperlinks and URLs to other web pages, contact information, etc. It is also appreciated that the online content in the form of data 111 need not be a webpage, and can instead take the form of presentation slides (e.g., PowerPoint® or Google Slides™), a document (e.g., Microsoft Word®, Google Docs™, PDF, etc.), a webinar, etc.

It is appreciated that the data 111 can have a plurality of texts. In one nonlimiting example, the data 111 may be a webpage displayed through the online collaborative platform 130. In accordance with this example, the plurality of texts within the webpage may take the form of an individual word, a combined term or phrase, a URL, a word or phrase that includes a hyperlink, etc. It is appreciated that one or more of the plurality of texts of the data 111 can be interactable, e.g., links to navigate to a webpage to navigate to a video clip to navigate to a Wiki page, text that can be selected and copied, etc. In the same webpage example, the webpage may include a URL to a third-party distributor's website. The URL text is interactable because it allows the presenter, while viewing the webpage, to select the URL and open it in a web browser. At the same time, data 111 need not include only interactable text and may also include non-interactable text.

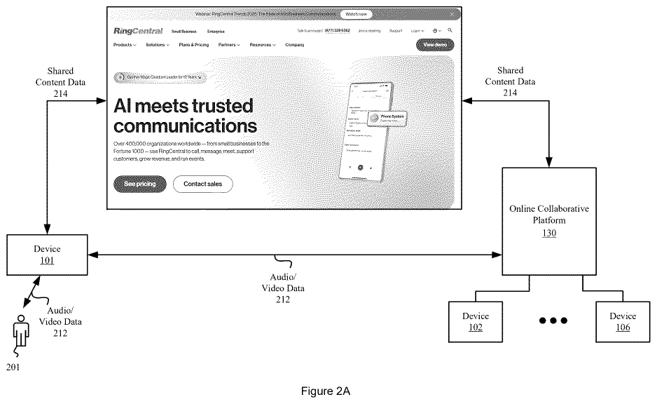

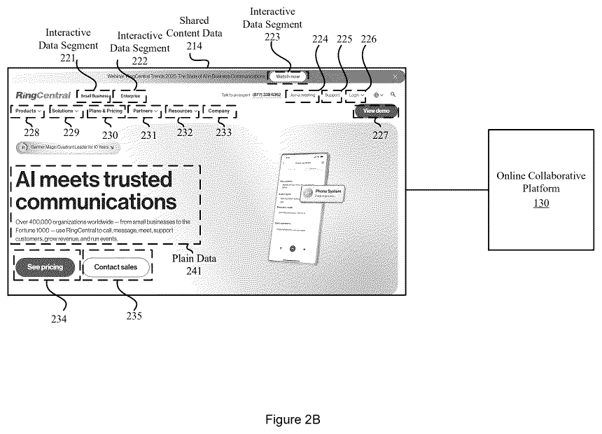

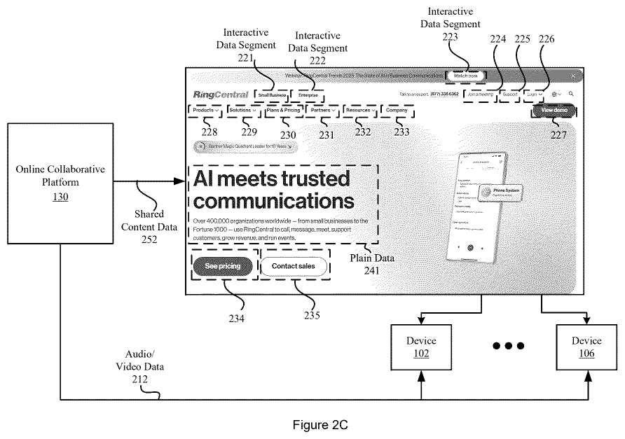

FIG. 2A depicts a diagram of a user sharing content through an online collaborative platform, according to some embodiments. In accordance with FIG. 2A, user 201, through device 101, is presenting audio/video data 212 and shared content data 214 through an online collaborative platform 130. The online collaborative platform 130 may subsequently process the audio/video data 212 and the shared content data 214 and transmit it to the audience members through devices 102-106. In accordance with one nonlimiting example, the audio/video data 212 can include user 201 speaking about the content being displayed (audio data) through an external audio device connected to or within device 101, such as a microphone, and/or a video of user 201 (video data) being recorded by a video capture device connected to or within device 101, such as a web camera. In accordance with FIG. 2A, the shared content data 214 is in the form of an Internet webpage. It is appreciated that this is just one nonlimiting example, as the shared content data 214 can take several forms, including a document (e.g., Microsoft Word®, Google Docs™, PDF, etc.), a slideshow presentation (e.g., PowerPoint® or Google Slides™), etc. It is further appreciated that the shared content data 214 may also include the metadata associated with the online content being presented. It is appreciated that while the shared content data 214 is interactable by the presenter 201, it is not interactable when received (shared) with users associated with devices 102-106. For example, a link within the shared content data 214 may be interacted with by the presenter 201 to navigate to a webpage associated with the link whereas the users associated with devices 102-106 cannot interact with the link within the shared content data 214.

Referring now to FIG. 2B, a diagram of an online collaborative platform identifying interactable and non-interactable data within a webpage, according to some embodiments is shown. In accordance with FIG. 2B, the online collaborative 130 is processing and analyzing the shared content 214. In accordance with some embodiments, the shared content data 214 can include both interactable and non-interactable text. In accordance with FIG. 2B, the shared content data 214 includes interactive data segments 221-235. Interactive data segments 221-235 are interactive, or interactable, because a user (presenter) viewing the webpage contained in the shared content data 214 can use an input device (e.g., a mouse) to select (e.g., click on) the text and be taken to another webpage or be provided with a list of information. For example, if a user clicks on “See pricing” in the interactive data segment 234, the user is taken to another webpage with pricing information. As another nonlimiting example, a text may be interactable in a sense that a user (presenter) can select the text (e.g., by double clicking the text or by clicking and dragging the mouse to select a portion of the content) and to copy the text or to perform other operations associated with the selected text (described in more detail in subsequent figures). In accordance with some embodiments, the online collaborative platform 130 may process and analyze the shared content data 214 to identify a plurality of texts, to determine if one or more of the plurality of texts is interactable, and, if so, to determine which text is interactable and which is non-interactable. It is appreciated that, in processing and analyzing the shared content data 214, the online collaborative platform may also process and analyze the metadata associated with the shared content data 214.

In the example of FIG. 2B, the online collaborative platform 130 can process the shared content data 214 and determine that it includes interactive data segments 221-235. Considering the above example, the online collaborative platform 130 can extract the text within interactive data segment 234, determine that the “See pricing” text leads to another webpage with pricing information, and thus identify the text within interactive data segment 234 as interactable. In another nonlimiting example, the online collaborative platform may determine that the “See pricing” text leads to another webpage with pricing information by processing the metadata associated with the “See pricing” text to determine that clicking on the button leads the user to a different webpage. At the same time, the online collaborative platform 130 can determine which of the plurality of texts is not interactable. In the example of FIG. 2B, the online collaborative platform 130 can analyze the box containing plain data 241 and determine that the text is not interactable because no portion of plain data 241 can be selected and/or further interacted with. In this example, when the shared content data 214 is presented to an audience through the online collaborative platform 130, all interactive data segments 221-235 are presented in plain text and cannot be interacted with by the audience in the same way that the presenter can. Given the inability of the audience to interact with the interactive data segments 221-235, delays or audience distractions may occur as the audience tries to find the relevant information while the presentation is ongoing. This is especially so in instances such as interactive data segment 221, where the phrase “Small Business” is a phrase with an embedded URL. The audience members may be unaware of the embedded URL and, even if they are aware that a URL is embedded, are unable to write down the embedded URL.

Referring now to FIG. 2C, an example is shown of an online collaborative platform 130 transmitting the shared content 252 to an audience with interactable text, according to some embodiments. In accordance with FIG. 2C, the online collaborative platform 130 transmits shared content data 252 to devices 102 to 106, where shared content data 252 can now be interacted with by the audience once received. After identifying interactive data segments 221-235 from the shared content 214 (that is not interactable), the online collaborative platform 130 can enable interaction with these interactive data segments 221-235 by extracting the text associated with the interactive data segments 221-235 and changing it into an interactable format before transmitting the shared content data 252 (now interactable) to the audience. For example, after identifying interactive data segment 234, the online collaborative platform 130 can extract the “See pricing” text from the plain text received from the shared content 214 and may identify the interactable element associated with the extracted text. For example, the interactable element may be a hyperlink associated with the extracted text, “See pricing” in this example. In one nonlimiting example, the online collaborative platform 130 may change the format of the extracted text to transform it into interactable text, e.g., by embedding a hyperlink associated with the interactive data segment 234 into the extracted text “See pricing”. In yet another example, computer vision may be used to identify the positioning of the interactive data segment 234 and insert the identified interactable element where the extracted text “See pricing” is positioned such that when transmitted the audience can interact with the interactable element and perform one or more operations, e.g., select the extracted text and/or copy, select the extracted text that navigates to a webpage or document, etc.

In accordance with some embodiments, the audience can select the interactable 234 element, e.g., “See pricing” text, of the shared content 252 and subsequently navigates to the online address of the pricing information being linked. In yet one nonlimiting example, the audience may select the interactable 234 element of the shared content data 252 that navigates to a document associated with “pricing.” It is appreciated that while interactable elements 221-235 may be interacted with by the audience when received as shared content 252 other elements of the shared content 252 may not be interactable and may be received as plain data (e.g., plain data 241). It is appreciated that the interaction and the operation being performed with respect to the interactable element is provided for illustrative purposes and should not be construed as limiting the scope of the embodiments. For example, as will be discussed in further detail below, the audience may select other operations with respect to the interactable text, such as translating the interactable text, summarizing the interactable text, copying the interactable text, highlighting the interactable text, providing additional information with respect to the interactable element, providing a meaning associated with an interactable element, etc. The manner of selection may be via an input device, e.g., mouse and clicking buttons, voice command, hovering cursor over an interactable element, etc. By doing so, it is appreciated that delays and/or audience distractions can be mitigated by allowing the audience to interact with the shared content as displayed rather than having to write down the information while the presentation is ongoing. Furthermore, by doing so, it is appreciated that the audience will be able to determine all instances of interactable text and will be less likely to miss any embedded links. Also, it is appreciated that the need for the presenter or co-presenter to put the information such as link, emails, website addresses, etc., in the chat box is eliminated since the audience can now directly interact with the content being shared.

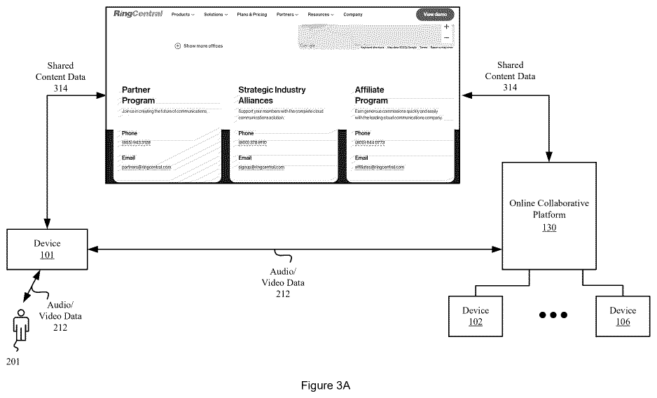

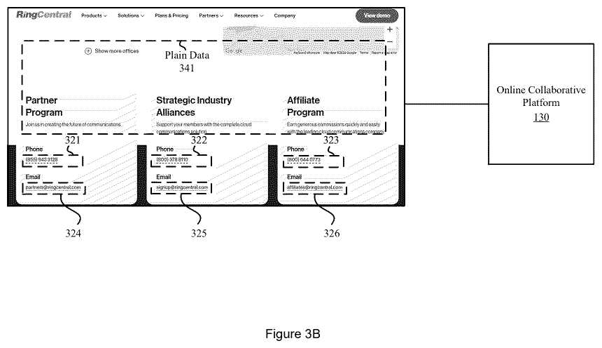

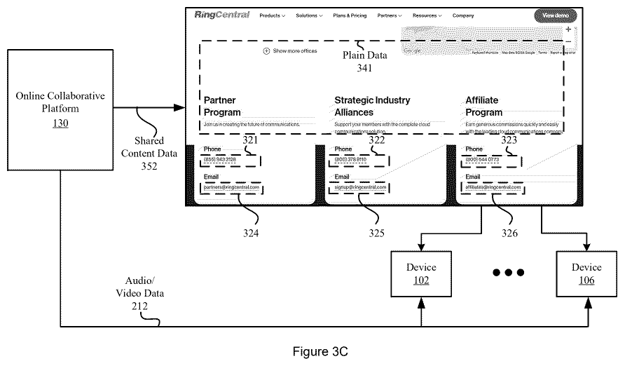

FIGS. 3A-3C show an example of a user sharing another content through an online collaborative platform and the online collaborative platform transmitting the shared content in addition to interactable elements, according to some embodiments. Referring now to FIG. 3A, user 201 is using device 101 to present shared content data 314 and provide audio/video data 212 through the online collaborative platform 130. Similar to FIG. 2A and as discussed above, the online collaborative platform 130 may process the audio/video data 212 and the shared content data 314, and transmit audio/video data 212 and the shared content data 314 to the audience members through devices 102-106.

Referring now to FIG. 3B, an example is shown where the online collaborative platform 130 processes and analyzes the shared content data 314. Similar to FIG. 2B and as discussed above, the online collaborative platform 130 may process and analyze the shared content data 314 to identify a plurality of texts, to determine if one or more of the plurality of texts is interactable or should be made interactable, and, if so, to determine which text is interactable and which is non-interactable. In the example of FIG. 3B, the online collaborative platform 130 can identify the interactive data segments 321-326. In this example, the interactable text is in the form of URLs that can be selected by users. For example, the online collaborative platform 130 may determine that the URL in box 324 is interactive because it allows users to select the email address URL and subsequently opens a blank email addressed to the email the selected address. At the same time, the online collaborative platform can identify plain data 341 and determine that it contains only non-interactable text that cannot be selected or otherwise interacted with. In response to making these determinations, the online collaborative platform may then extract the text, enable interaction with the text that should be interactable, and transmit the online content in a form that includes interactable text that the audience can select and interact with as well as transmitting text that is not interactable and should not be interactable.

Referring now to FIG. 3C, an example is shown where the content is shared with the audience with interactable text. Similar to FIG. 2C and as discussed above, the shared content data 352 is transmitted to the audience in a form that includes interactable text that the audience can select and interact with as well as text that is not interactable. In the example of FIG. 3C, the audience can again select the interactive data segments 321-326. In accordance with some embodiments, the audience member can select the interactable text and to navigate to an online address associated with the interactable text. For example, as discussed above with respect to FIG. 2C, an audience member may select the email address in box 324 and navigate to a blank email addressed to the email address selected. However, it is appreciated that this is just one nonlimiting example as audience members, when interacting with text in interactive data segments, can perform operations other than being taken to another online address. In accordance with some embodiments, the audience member may select the email address in box 324 and then copy the email address. In another nonlimiting example, the audience member may select the email address in box 324 and highlight the email address. In yet other embodiments, a user may select the phone number in one of the interactive data segments 321-323 and initiate a phone call with the phone number contained in the interactable text. By doing so, it is appreciated that delays and/or audience distractions can be mitigated by allowing the audience to interact with the URLs as displayed rather than having to use more time-consuming and distracting methods such as finding the webpage or re-typing and saving the information. Moreover, the need for the presenter having to put the information associated with the elements in the chat box is eliminated since the audience may interact with the interactable elements directly.

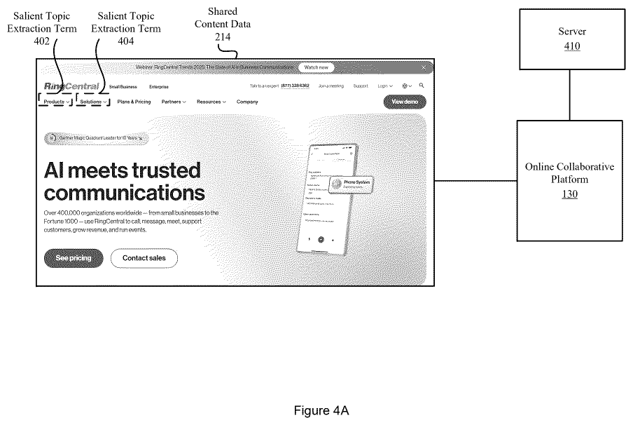

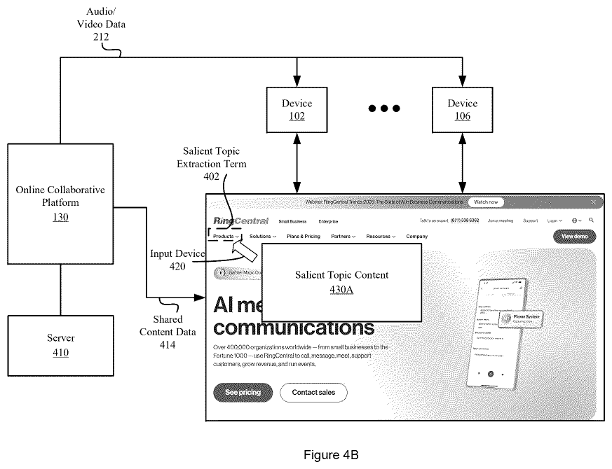

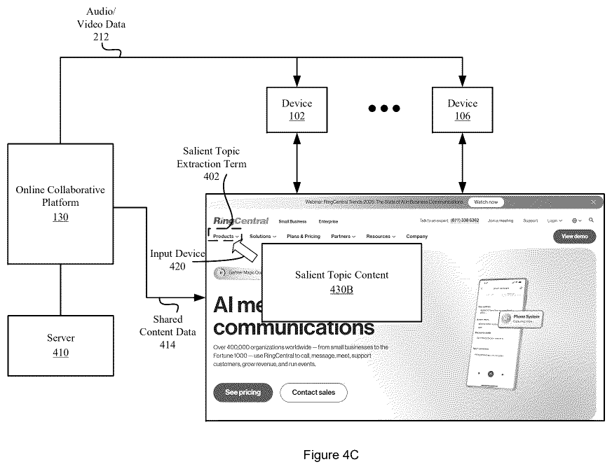

FIGS. 4A-4C provide an example where different information related to interactable text is transmitted to different audience members, according to some embodiments. Referring now to FIG. 4A, shared content data 214 is once again provided to the audience through online collaborative platform 130. Similar to FIG. 2A and as discussed above, the shared content data 214 is a webpage containing both interactable and non-interactable text. In accordance with FIG. 4A, the online collaborative platform 130 is now connected to a server 410. In accordance with some embodiments, the online collaborative platform 130 may use AI/ML (e.g., by performing NLP) to identify text that is associated with additional information contained within server 410. For example, the online collaborative platform 130 can identify the terms “Products” and “Solutions” as salient topic extraction terms 402 and 404, respectively. The online collaborative platform 130 may use AI/ML to extract the two terms and subsequently access the server 410 that contains additional information about the “Products” and “Solutions,” in order to complement the salient topic extraction terms 402 and 404 when the content is shared with the audience. In doing so, the online collaborative platform has identified that server 410 contains additional information about the terms “Products” and “Solutions” that can be transmitted to the audience member. Considering salient topic extraction term 402, the online collaborative platform may process the term “Products” and determine that the server 410 contains additional information about the RingCentral “Products” that is not contained in the shared content data 214. For example, server 410 may contain information such as lists of all released and unreleased products. In accordance with some embodiments, the online collaborative platform 130 may make this determination by processing the metadata associated with the shared content data 414.

Referring now to FIG. 4B, the online collaborative platform 130 now provides shared content data 414. Similar to FIG. 2C and as discussed above, the shared content data 414 includes interactable text provided by the online collaborative platform 130 that audience members can select and interact with. In accordance with some embodiments, an audience member can use an input device 420 (e.g., a mouse) to select (e.g., click on or hover over) the salient topic extraction term 402. It is appreciated that using a mouse to click on the interactable text is just one manner of selecting the interactable text and is not intended to be limiting. For example, an audience member may instead select the interactable text by hovering the mouse cursor over the interactable text. In another nonlimiting example, the audience member may make the selection via a voice command—for example, in FIG. 4B, if the audience member says “Products.”

In response to the audience member selecting the salient topic extraction term 402 (“Products”), the online collaborative platform 130 can provide the audience member with salient topic content 430A that was previously identified as being related to the term “Products.” The salient topic content 430A can be information about the salient topic extraction term 402 being selected that is being supplemented using the server 410. For example, if an audience member selects the salient topic extraction term 402, the salient topic content 430A may include an internal list contained within server 410 that shows lists of both released RingCentral products and RingCentral products currently in development. It is appreciated that, as discussed in further detail below, the salient topic content being provided to the audience member may vary depending on who the audience member is.

Referring now to FIG. 4C, the online collaborative platform 130 now provides salient topic content 430B in response to a different audience member selecting salient extraction term 402. Compared to FIG. 4B, the salient topic content 430B contains different information than the salient topic content 430A. In accordance with some embodiments, the online collaborative platform 130 may provide a customized set of salient topic content based on a profile of the audience member selecting the salient topic extraction term. Meaning, the online collaborative platform 130 can determine the profile associated with the audience member who selected the term and subsequently provide a unique set of information based on the nature of the audience member's profile. In one nonlimiting example, the audience member's profile may be associated with the permissions of the audience member. For example, compare a contractor who has limited access to confidential information with an internal developer with the highest access to confidential information. In this example, upon selecting salient topic extraction term 402, an internal developer may receive salient topic content 430A (i.e., a list of both released and unreleased products) whereas a contractor may only receive a list of released products in the form of salient topic content 430B. It is appreciated that the audience member profiles can be customized in any number of ways and need not be differentiated based on the audience member's permissions. In one nonlimiting example, the audience member profiles may be associated with age, where different sets of salient topic content are provided to the audience members dependent on their age. Other profile information may be used to customize the data that is being provided. Other profile information include gender, educational background, title at an organization, projects involved in, years of experience, expertise, etc.

In accordance with some embodiments, the determination of whether an audience member receives salient topic content 430A or salient topic content 430B may be achieved by the online collaborative platform 130 processing the metadata associated with the shared content data 414 and/or the salient topic extraction term 402. Continuing the above example, structural metadata may inform the online collaborative platform 130 that the salient topic extraction term 130 is associated with two lists of products—one with unreleased and released products, and another with only released products. Then, the online collaborative platform 130 may process administrative metadata of the two product lists to determine that the list of both unreleased and released products has a higher permission level than the list of only released products, allowing the online collaborative platform 130 to determine which audience members will receive access to each list of products.

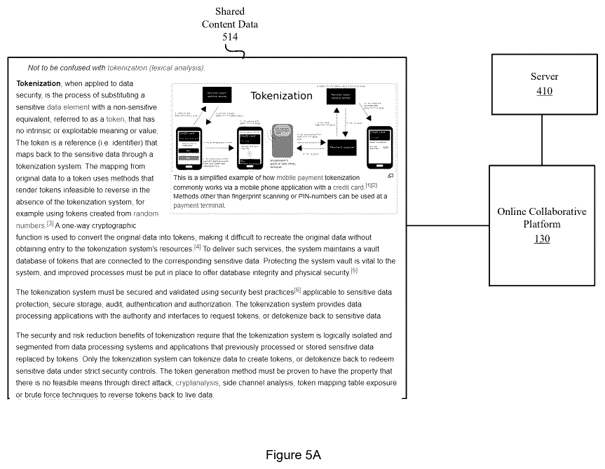

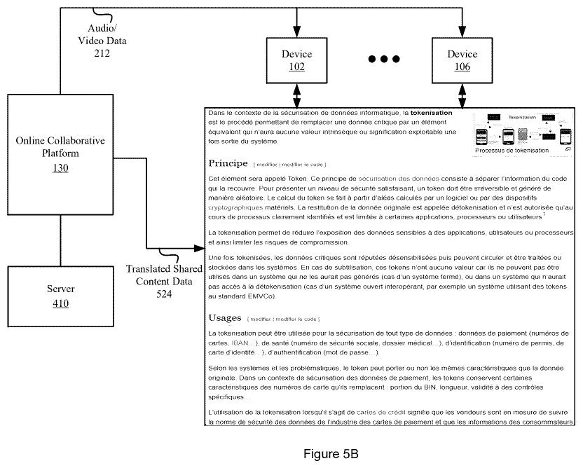

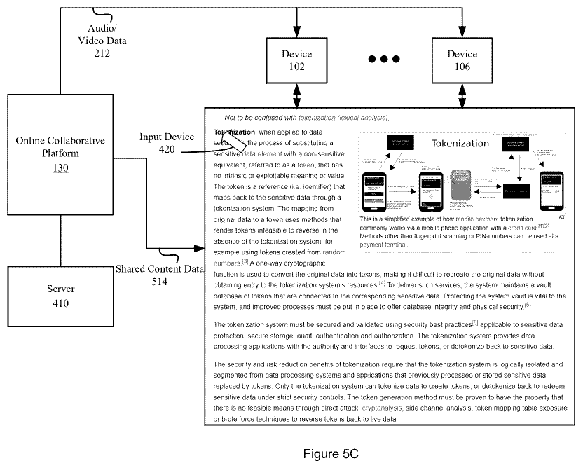

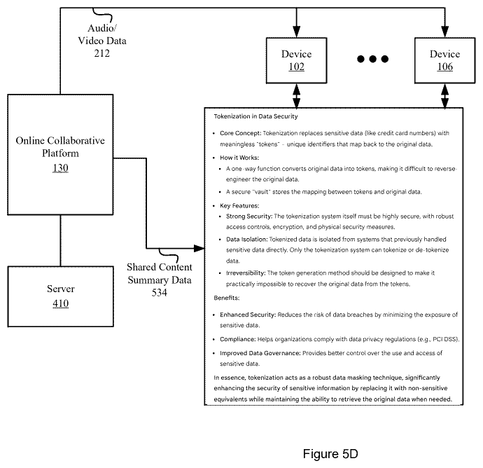

FIGS. 5A-5D show an example where NLP is used to translate and summarize interactable text, according to some embodiments. Referring now to FIG. 5A, shared content data 514 in the form of an online webpage is presented through the online collaborative platform 130. Similar to FIG. 4A and as discussed above, the online collaborative platform 130 is connected to server 410. Referring now to FIG. 5B, the online collaborative platform 130 transmits translated shared content data 524, which in this example is the translation of the shared content data 514 from English into French. It is appreciated that the online collaborative platform may utilize AI/ML, such as NPL, in order to process the interactable text and subsequently translate the interactable text to another selected language. In accordance with some embodiments, an audience member may select the interactable text within the shared online content and request that the online collaborative platform 130 translate the interactable text into another language. In the example of FIG. 5B, in response to an audience member requesting that the interactable text be translated to French, the online collaborative platform 130 provides the online content entirely in French (i.e., translated shared content data 524). It is appreciated that the translation may occur automatically by configuring the user preferences ahead of time or it may be done in real-time by the user (audience) selecting the text to be translated. It is appreciated that the translation from English to French is for illustrative purposes only and is not intended to be limiting. Rather, the online collaborative platform 130 can utilize AI/ML in order to translate between any two languages. Additionally, the online collaborative platform 130 need not translate all interactable text within the shared online content and may instead translate only selected portions of the interactable text. By doing so, this mitigates potential delays and audience distraction that would otherwise be caused by the audience members'need to translate the text themselves or find another translated version of the text while the presentation is ongoing.

Referring now to FIG. 5C, shared content data 514 is once again being presented in untranslated form. Similar to FIG. 4B and as discussed above, the shared content data 514 may contain interactable text that an audience member can select with an input device 420. Similar to FIG. 4B and as discussed above, an audience member may select interactable text by clicking on the text with a mouse, hovering over the text with a mouse, utilizing a voice command, etc. In accordance with some embodiments, in response to an audience member selecting interactable text within the shared content data 514, the online collaborative platform 130 may utilize NLP in order to provide a summary of the interactive text selected. In response to an audience member using input device 420 to select the word “Tokenization,” the online collaborative platform 130 can provide a summary of “Tokenization” (in this example, as shared content summary data 534). Referring now to FIG. 5D, the online collaborative platform 130 transmits shared content summary data 534. Although FIG. 5D shows that the summary is opened in a new web page or window, it is appreciated that this example is nonlimiting and may be transmitted in other manners. For example, similar to FIGS. 4B and 4C, the summary may instead be rendered on top of the original shared content data 514. Although the current state of the art relies on NLP to process and summarize audio data presented through an online collaborative platform, it is appreciated that the embodiments provided herein leverage ML/AI to further process and summarize documents and/or text being shared through an online collaborative platform as opposed to only audio data. By doing so, it mitigates the potential for delays and audience confusion caused by the audience having to seek this information on their own time or during the presentation. It is further appreciated that providing a summary of the interactable text is used for illustrative purposes only and is not limited. For example, in accordance with other embodiments, the online collaborative platform 130 may instead provide a definition or meaning of the interactable text (e.g., “Tokenization”) upon an audience member interacting with it, rather than a summary of what the interactable text says.

Typically, the content being shared cannot be interacted with by the audience whereas the embodiments have enabled the presenter to share content with the audience in an interactable fashion. For example, traditionally the audience were not able to click on a link being shared during a presentation, select a text to highlight or to copy, instantiate a link to compose an email or to navigate to an online address (internal or external) or to open a document, fetch the meaning of a term by selecting a term automatically, fetch additional information regarding a term by merely selecting the term, translating the term, fetching a meaning of a term, etc. Moreover, while various NLP have been leveraged to summarize a meeting content, the summarization has been only directed to the audio of spoken words as opposed to the content being shared, e.g., power point, document, website, etc. The embodiments, as described above, enable the audience to interact with the content being shared, e.g., to click on a link, select a text and/or highlight a selected text and/or copy the selected text, instantiate a link to compose an email or to navigate to an online address (internal or external) or to open a document, instantiate a link to place a call, fetch the meaning of a term by selecting a term automatically, fetch additional information regarding a term by merely selecting the term, translating a term, fetching a meaning of a term, summarizing a portion of the content being shared, etc.

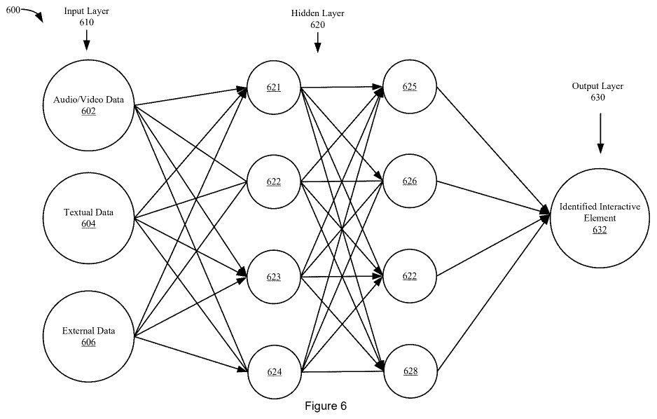

In the example of FIG. 6, the input layer 610 includes a plurality of training datasets that are stored as a plurality of training input matrices in an associated database. The training input data includes, for example, audio/video data 602, textual data 604 and external data 606. The audio/video data 602 may be related to communication (audio/video) between users during online meeting, e.g., webinar. In one nonlimiting example, the audio/video data 602 may be the audio/video of the presentation being made, e.g., of the presenter and the audience, feedback of the audience, question/answer session, etc. In one nonlimiting example, the textual data 604 may include the presentation being made, e.g., presentation slides, etc., as described above. The textual data 604 may include Short Message Service (SMS) or Multimedia Messaging Service (MMS) messages, messaging applications messages, collaboration tool messages, e-mail messages, transcriptions, files being shared, presentation being made, chat messages, etc. The external data 606 may include data from a server, hyperlinks associated with the content being presented on, etc. While the example of FIG. 6 uses a single neural network for audio/video data 602, textual data 604, and external data 606, in some embodiments, separate neural networks may be used in association with any set of training data. Any number of neural networks may be used to train.

In the embodiment of FIG. 6, hidden layers 620 represent various computational nodes 621, 622, 623, 624, 625, 626, 627, 628. The lines between each node 621, 622, 623, 624, 625, 626, 627, 628 represent weighted relationships based on the weight matrix. As discussed above, the weight of each line is adjusted overtime as the model is trained. While the embodiment of FIG. 6 features two hidden layers 620, the number of hidden layers is not intended to be limiting. For example, one hidden layer, three hidden layers, ten hidden layers, or any other number of hidden layers may be used for a standard or deep neural network. The example of FIG. 6 also features an output layer 630 with identifiable interactive element 632, as described in FIGS. 1-5D above, as the known output. The identifiable interactive element 632 indicates that a text within the shared content that is being presented on should be made interactive or not, as described above. As discussed above, in this structured model, the identifiable interactive element 632 is used as a target output for continuously adjusting the weighted relationships of the model. When the model successfully outputs the mismatch identification/matching content 632, then the model has been trained and may be used to process live or field data.

Once the neural network 600 of FIG. 6 is trained, the trained ML module 150 will accept field data at the input layer 610, such as current communication, e.g., text, audio/video, file exchanged, screen shared, presentation being made, video clips being played, demo being performed, etc., as well as external data, e.g., prior emails, telephone calls, messages, etc. In some embodiments, the field data is live data that is accumulated in real time, such as a live streaming video and/or audio of a conference session. In other embodiments, the field data may be current data that has been saved in an associated database. The ML module may apply the field data to identify texts that should be made interactive that is/are being presented on such that they can be made interactive when transmitted to the audience.

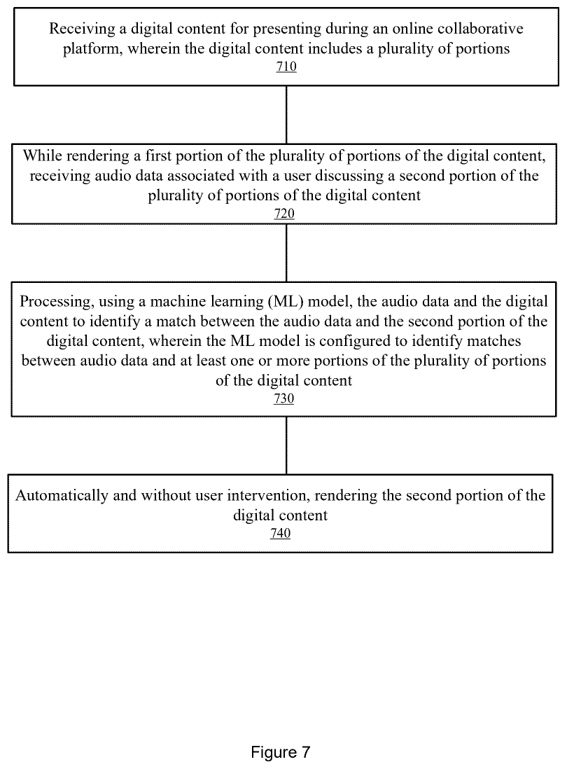

FIG. 7 depicts a flowchart for creating elements that are interactable when shared with an online content, according to some embodiments. At step 710, online content that is being shared with participants of an online collaborative platform is received. At step 720, the online content being shared is processed in order to extract a plurality of texts from the online content. At step 730, out of the plurality of texts, at least one extracted text is identified to be interactable. At step 740, interaction is enabled with the at least one extracted text in order to form an interactable text. At step 750, the online content being shared is transmitted to participants with the interactable text. It is appreciated that, in response to a selection by a participant, an operation associated with the interactable text is performed.

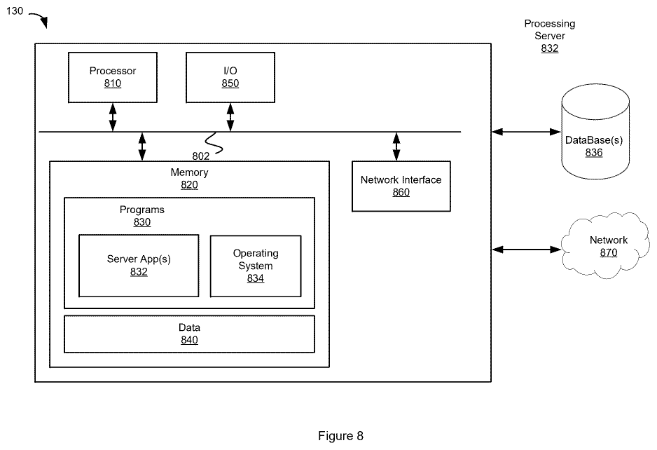

FIG. 8 shows a diagram of an example of online collaborative platform 130, consistent with the disclosed embodiments. The online collaborative platform 130 includes a bus 802 (or other communication mechanism) which interconnects subsystems or components for transferring information within the online collaborative platform 130. As shown, the online collaborative platform 130 includes one or more processors 810, input/output (“I/O”) devices 850, network interface 860 (e.g., a modem, Ethernet card, or any other interface configured to exchange data with the network 870), and one or more memories 820 storing programs 830 including, for example, server app(s) 832, operating system 834, and data 840, and can communicate with an external database 836 (which, for some embodiments, may be included within the online collaborative platform 130). The online collaborative platform 130 may be a single server or may be configured as a distributed computer system including multiple servers, server farms, clouds, or computers that interoperate to perform one or more of the processes and functionalities associated with the disclosed embodiments.

The processor 810 may be one or more processing devices configured to perform functions of the disclosed methods, such as a microprocessor manufactured by Intel™ or manufactured by AMD™. The processor 810 may comprise a single core or multiple core processors executing parallel processes simultaneously. For example, the processor 810 may be a single core processor configured with virtual processing technologies. In certain embodiments, the processor 810 may use logical processors to simultaneously execute and control multiple processes. The processor 810 may implement virtual machine technologies, or other technologies to provide the ability to execute, control, run, manipulate, store, etc. multiple software processes, applications, programs, etc. In some embodiments, the processor 810 may include a multiple-core processor arrangement (e.g., dual, quad core, etc.) configured to provide parallel processing functionalities to allow the online collaborative platform 130 to execute multiple processes simultaneously. It is appreciated that other types of processor arrangements could be implemented that provide for the capabilities disclosed herein.

The memory 820 may be a volatile or non-volatile, magnetic, semiconductor, tape, optical, removable, non-removable, or other type of storage device or tangible or non-transitory computer-readable medium that stores one or more program(s) 830 such as server apps 832 and operating system 834, and data 840. Common forms of non-transitory media include, for example, a flash drive a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The online collaborative platform 130 may include one or more storage devices configured to store information used by processor 810 (or other components) to perform certain functions related to the disclosed embodiments. For example, the online collaborative platform 130 may include memory 820 that includes instructions to enable the processor 810 to execute one or more applications, such as server apps 832, operating system 834, and any other type of application or software known to be available on computer systems. Alternatively or additionally, the instructions, application programs, etc. may be stored in an external database 836 (which can also be internal to the online collaborative platform 130) or external storage communicatively coupled with the online collaborative platform 130 (not shown), such as one or more database or memory accessible over the network 870.

The database 836 or other external storage may be a volatile or non-volatile, magnetic, semiconductor, tape, optical, removable, non-removable, or other type of storage device or tangible or non-transitory computer-readable medium. The memory 820 and database 836 may include one or more memory devices that store data and instructions used to perform one or more features of the disclosed embodiments. The memory 820 and database 836 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

In some embodiments, the online collaborative platform 130 may be communicatively connected to one or more remote memory devices (e.g., remote databases (not shown)) through network 870 or a different network. The remote memory devices can be configured to store information that the online collaborative platform 130 can access and/or manage. By way of example, the remote memory devices could be document management systems, Microsoft SQL database, SharePoint databases, Oracle™ databases, Sybase™ databases, or other relational databases. Systems and methods consistent with disclosed embodiments, however, are not limited to separate databases or even to the use of a database.

The programs 830 include one or more software modules configured to cause processor 810 to perform one or more functions consistent with the disclosed embodiments. Moreover, the processor 810 may execute one or more programs located remotely from one or more components of the online collaborative platform 130. For example, the online collaborative platform 130 may access one or more remote programs that, when executed, perform functions related to disclosed embodiments.

In the presently described embodiment, server app(s) 832 causes the processor 810 to perform one or more functions of the disclosed methods. For example, the server app(s) 832 cause the processor 810 to receive conference information, such as conference participants, communications of the conference participants; determine, based on the received communications of the conference participants whether to place the next user in a temporary virtual conference room or in the virtual conference room, when to merge the temporary virtual conference room into the virtual conference room, and determine/predict when the current meeting will end and whether subsequent allotted time intervals for subsequent users should be modified. In some embodiments, other components of the online collaborative platform 180 may be configured to perform one or more functions of the disclosed methods.

In some embodiments, the program(s) 830 may include the operating system 834 performing operating system functions when executed by one or more processors such as the processor 810. By way of example, the operating system 834 may include Microsoft Windows™, Unix™, Linux™, Apple™ operating systems, Personal Digital Assistant (PDA) type operating systems, such as Apple iOS, Google Android, Blackberry OS, or other types of operating systems. Accordingly, disclosed embodiments may operate and function with computer systems running any type of operating system 834. The online collaborative platform 130 may also include software that, when executed by a processor, provides communications with the network 870 through the network interface 860 and/or a direct connection to one or more user devices 101-109.

In some embodiments, the data 840 may include, conference information received from user devices 101-106, shared content, audio/video data, etc.

The online collaborative platform 180 may also include one or more I/O devices 850 having one or more interfaces for receiving signals or input from devices and providing signals or output to one or more devices that allow data to be received and/or transmitted by the online collaborative platform 130. For example, the online collaborative platform 130 may include interface components for interfacing with one or more input devices, such as one or more keyboards, mouse devices, and the like, that enable the online collaborative platform 130 to receive input from an operator or administrator (not shown).

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. A computer-implemented method to interact with an online content being shared, the method comprising:
receiving the online content being shared with a participant of an online collaborative session;
processing the online content being shared to extract a plurality of texts from the online content being shared;
identifying at least one extracted text from the plurality of texts to be interactable;
enabling interaction with the at least one extracted text to form an interactable text; and
transmitting the online content being shared with the interactable text to the participant, wherein an operation associated with the interactable text is performed in response to a selection by the participant.

2. The computer-implemented method of claim 1, wherein the operation is navigating to an online address associated with the interactable text.

3. The computer-implemented method of claim 1, wherein the operation is highlighting the interactable text.

4. The computer-implemented method of claim 1, wherein the operation is copying the interactable text.

5. The computer-implemented method of claim 1, wherein the operation is providing additional information associated with the interactable text.

6. The computer-implemented method of claim 5, wherein the additional information associated with the interactable text for the participant is different from another additional information associated with the interactable text for a different participant of the online collaborative session, and wherein the additional information and the another additional information are customized based on a profile associated with the participant and the different participant respectively.

7. The computer-implemented method of claim 6, wherein the profile is associated with a permission of the participant and the different participant respectively.

8. The computer-implemented method of claim 6, wherein the profile is associated with an age of the participant and the different participant respectively.

9. The computer-implemented method of claim 1, wherein the operation is providing a meaning associated with the interactable text.

10. The computer-implemented method of claim 1, wherein the operation is translating the interactable text to a different language.

11. The computer-implemented method of claim 1, wherein the operation is providing a summary of the interactable text.

12. The computer-implemented method of claim 11 further comprising performing natural language processing (NLP) to provide the summary of the interactable text.

13. The computer-implemented method of claim 1, wherein the operation is initiating a phone call associated with the interactable text.

14. The computer-implemented method of claim 1, wherein the selection is through a click button of a mouse on the interactable text.

15. The computer-implemented method of claim 1, wherein the selection is through a hovering of a mouse over the interactable text.

16. The computer-implemented method of claim 1, wherein the selection is via a voice command.

17. A system for interacting with an online content being shared, comprising:
a processor; and
a memory, storing a set of instructions, that when executed by the processor, causes:
receiving the online content being shared with a participant of an online collaborative session;
processing the online content being shared to extract a plurality of texts from the online content being shared;
identifying at least one extracted text from the plurality of texts to be interactable;
enabling interaction with the at least one extracted text to form an interactable text; and
transmitting the online content being shared with the interactable text to the participant, wherein an operation associated with the interactable text is performed in response to a selection by the participant.

18. The system of claim 17, wherein the operation is one of navigating to an online address associated with the interactable text, highlighting the interactable text, copying the interactable text, providing additional information associated with the interactable text, providing a meaning associated with the interactable text, translating the interactable text to a different language, providing a summary of the interactable text, or initiating a phone call associated with the interactable text.

19. The system of claim 18, wherein the additional information associated with the interactable text for the participant is different from another additional information associated with the interactable text for a different participant of the online collaborative session, and wherein the additional information and the another additional information are customized based on a profile associated with the participant and the different participant respectively.

20. The system of claim 19, wherein the profile is associated with a permission of the participant and the different participant respectively or with an age of the participant and the different participant respectively.

21. The system of claim 18, wherein the set of instructions when executed by the processor causes performing natural language processing (NLP) to provide the summary of the interactable text.

22. The system of claim 17, wherein the selection is through a click button of a mouse on the interactable text or a hovering of a mouse over the interactable text or a voice command.

23. A non-transitory, computer-readable medium storing a set of instructions that, when executed by a processor, cause:
receiving the online content being shared with a participant of an online collaborative session;
processing the online content being shared to extract a plurality of texts from the online content being shared;
identifying at least one extracted text from the plurality of texts to be interactable;
enabling interaction with the at least one extracted text to form an interactable text; and
transmitting the online content being shared with the interactable text to the participant, wherein an operation associated with the interactable text is performed in response to a selection by the participant.
